(19) United States
(12) Patent Application Publication
(10) Pub. No.: US 2016/0120001 A1
(43) Pub. Date: Apr. 28, 2016

(54) Color temperature tuning

(71) Applicant: FINELITE INC., Union City, CA (US)

(72) Inventors: Walter Blue Clark, Palo Alto, CA (US); Aaron Matthew Smith, Fremont, CA (US)

(73) Assignee: FINELITE INC., Union City, CA (US)

(21) Appl. No.: 14/756,897

(22) Filed: Oct. 27, 2015

Related U.S. Application Data
(60) Provisional application No. 62/122,621, filed on Oct. 27, 2014.
(60) Provisional application No. 62/178,705, filed on Apr. 17, 2015.
(60) Provisional application No. 62/230,798, filed on Jun. 15, 2015.

(51) Int. Cl. H05B 33/08; H05B 37/02

(52) U.S. Cl. CPC H05B 33/0872; H05B 37/0272; H05B 37/0218; H05B 37/0227

(57) ABSTRACT

An advance control LED lighting system is disclosed. The lightings system includes LED light fixtures with sets of different white LED arrays that emit different output spectra. The system includes a control unit for adjusting relative intensities of light outputs from the different sets of white LED arrays as well as the combined intensity of light output from the different sets of white LED arrays to produce ranges combined output light intensities and the combined output light color temperatures. Preferably the control unit includes a wireless transmitter for receiving and processing input control signals from a remote control interface device, such as a smart-phone or computer. The system also includes sensors coupled to the control unit for automatically adjusting one or more of the combined output light intensity and the combined output light color temperature based on a measured or detected condition.

### RELATED APPLICATION

This application claims priority under 35 U.S.C. §119(e) from the co-pending U.S. provisional patent application Ser. No. 62/122,621, filed on Oct. 27, 2014, and titled “COLOR TEMPERATURE TUNING”, the co-pending U.S. provisional patent application Ser. No. 62/178,705, filed on Apr. 17, 2015, and titled “COLOR TEMPERATURE TUNING”, and the co-pending U.S. provisional patent application Ser. No. 62/230,798, filed on Jun. 15, 2015, and titled “COLOR TEMPERATURE TUNING”. The co-pending U.S. provisional patent applications Ser. Nos. 62/122,621, 62/178,705 and 62/230,798 are all hereby incorporated by reference.

### FIELD OF THE INVENTION

This invention relates to lighting systems. More specifically, this invention relates to Light Emitting Diode (LED) devices and systems.

### BACKGROUND

Mixing or combining different colors of light using incandescent lamps with filers to create new color outputs, light settings or mood setting has been done in theater or stage applications and display technologies for a very long time. In the early development of Light Emitting Diodes (LEDs), it was easier to manufacture LED's that emit colored light, such as red, green and blue.

Because LEDs have longer burn life-times and use less energy than incandescent bulbs, lighting engineers began to combine color LED's to produce white light. Combining red, green, and blue light-emitting diodes in the appropriate way allows lighting engineers to match the soft white light of incandescent bulbs. Also, combining red, green, and blue light-emitting diodes can be used to create other color light outputs or dynamic color light outputs for scores boards, advertisement boards and the like.

Because low cost white light emitting diodes are now available, blending or mixing of color LEDs for commercial or residential lighting application has largely been replaced with white light emitting diodes. White light emitting diodes are often characterized by a color temperature scale. The color temperature of any light source is the temperature of an ideal black-body radiator that radiates light of a comparable hue to that of the light source. White light emitting LED's generally do not emit pure white light, but rather they emit a component of pure white light and varying amounts overtone colors. An LED color temperature defines the amount of pure white, yellow, red and blue light emitted by the white light emitting diode. Another way to think of an LED color temperature is how “warm” or “cool” the light is that is emitted by white light emitting diode. A warmer white light emitting diode emits white light with overtone component of yellow or even red (corresponding to a lower color temperature), while a cooler white light emitting diode emits white light with overtone components of blue (corresponding to a higher color temperature.

### SUMMARY OF THE INVENTION

The present invention is directed to an advance control LED lighting system. Control commands, operational protocols or communication networks in the lighting system of the present invention utilize and number of standards, including Digital Signal Interface (DSI) 0-10 V lighting control signals and formats, Digital Addressable Lighting Interface (DALI) lighting control signals and formats, DMX512 (Digital Multiplex) control signals and formats or a combination thereof.

In accordance with the embodiments of the invention the system includes zones of LED light fixtures; each of the zones of LED light fixtures include one or more LED light fixtures. Each of the LED light fixtures within the system includes different sets of LEDs that emit different output spectra. In operation, light emitted from the different sets of LEDs combine to produce a combined output light intensity and combined output light color temperature. By adjusting the relative intensities of light outputs from the different sets of LEDs as well as the total combined intensity of the different sets of LEDs, the light fixtures are capable of being adjusted to produce selected or target combined output light intensities and selected or target combined output light color temperatures. Preferably, each of the LED light fixtures include a set of LEDs that emit a component of yellow light as well as a component of white light (warm white light-lower color temperature) and different set of LEDs that emit a component of blue light as well as well as a component of white light (cool white light-higher color temperature).

The system includes a control unit coupled to the LED light fixtures for controlling power to the LED light fixtures based on control command signals provides from any number of sensors, switches and control interface devices. The sensors preferably include daylight sensors that measure or detect an amount of ambient light, and/or color of ambient light. The daylight sensors provide control signals to the control unit to maintain a target combined output light intensity and the target output light color temperature resulting from the of light emitted by the light fixtures and light provided from ambient light. Where the sensors include a white light sensor, the system adjusts the total output intensity of the LED light fixtures as wells as the relative intensities of different LEDs within the LED light fixtures to compensate for the presence of white light provided by ambient light. Other sensors include occupancy sensors that adjust light outputs from the LED light fixtures based on the presence of people within a vicinity of the LED light fixtures or vicinity of the occupancy sensors.

The control unit includes all the necessary electrically components, including one or more computing units (CPUs) for running software and analyzing control signals received from sensors and control interface devices and connectors for coupling to and for powering the LED light fixtures. In accordance with the embodiments of the invention the control unit includes a wireless transmitter for receiving and processing input control signals from a remote control interface device, such as a smart-phone or computer.

In accordance with the embodiments of the invention a control interface device is a blue-tooth enabled device that has a touch screen. In operation, the control interface device “pairs” with a Bluetooth transducer coupled to the control unit. The control interface device runs software that generates one or more selectable graphical control interfaces that allows a user to input selected or target output light intensities and selected or target output light color temperatures. Preferably, one of the graphical control interfaces includes movable intersecting cross-hairs. In operation, a user drags or moves positions of the intersecting cross-hairs on the touchscreen of the control interface device to change or adjust the output light intensity and output light color temperature of the LED light fixtures.

In accordance with the method of the invention, white light is generated by emitting light form light fixture each having sets of different LEDs that emit different output spectra and that include a component of white light. As described above, the output spectra from the different LEDs combine to produce a combined output light intensity and a combined output light color temperature. In operation a target combined output light intensity and a target combined output light color temperature are selected through a graphical control interface on a control interface device. The control interface device then sends control signals or control commands to the CUP of the control unit and the control unit adjusting the relative intensities and the total combined intensities of light from the different sets of LEDs to reach the selected output light intensity and selected output light color temperature. Preferably, an amount of ambient light is measured or detected using one or more sensors and the control unit compensates or adjusts the output light intensities and the target output light color temperatures to include or compensate for the amount of ambient light measure or detected.

### BRIEF DESCRIPTION OF THE DRAWINGS

FIG. 1A is a schematic representation of an advanced control lighting system, in accordance with the embodiments of the invention.

FIG. 1B shows a view of a control interface device for controlling output lighting from an advanced control lighting system, in accordance with the embodiments of the invention.

FIG. 1C shows selectable graphical control interfaces operable from a remote control interface device for controlling output lighting from an advanced control lighting system, in accordance with the embodiments of the invention.

FIG. 2 shows a schematic representation of an advanced control lighting system with a wireless transducer for receiving and processing input control command signals from a remote control interface device, in accordance with the embodiments of the invention.

FIG. 3A shows schematic representation of a power control center for powering an advanced control lighting system of the present invention.

FIG. 3B shows a schematic representation of signals control center for controlling an advanced control lighting system of the present invention.

FIG. 4 shows a schematic representation of a user control interface for inputting control command signals and controlling an advanced control lighting system, in accordance with the embodiments of the invention.

FIG. 5 shows a schematic representation of an advanced control lighting system in accordance with a preferred embodiment of the invention.

FIG. 6 shows a schematic representation of a connection layout for an advanced control lighting system of the present invention.

### DETAILED DESCRIPTION OF THE INVENTION

The present invention is directed to a advanced control lighting system 100 includes a light fixture 101 with multiple LED arrays 104, 104′ and 104″ having different corresponding color spectra C₁, C₂, and C₃. Preferably each of the LED arrays 104, 104′ and 104″ emit a component of white light with a component of red, yellow or blue. In other words, the multiple LED arrays 104, 104′ and 104″ are formed form white LEDs that emit light with varying amounts of cool (higher color temperature) and warm (lower color temperature) white light.

The system also includes a control unit 103 in electrical communication with the light fixture 101. The control unit 103 is configured to independently control the light output intensities I₁, I₂ and I₃ of each of the of the LED arrays 104, 104′ and 104″, such that light emitted from the LED arrays 104, 104′ and 104″ combine to give a total light output intensity I_{T}. By varying the relative amounts or percentages of light output light intensities I₁, I₂ and I₃ emitted from each of the LED arrays, the color spectra C₁, C₂ and C₃ combine to produce a total color temperature C_{T} of the output light emitted by the light fixture 101 is varied. By maintaining relative amounts or percentages of output light I₁, I₂, and I₃ emitted from each of the LED arrays and simultaneously decreasing or increasing the light output light intensities I₁, I₂, and I₃, the total output light intensity I_{T} emitted from the light fixture is decrease or increased.

The system includes a user interface 105, also referred to herein as a control interface device.

The control interface device 105 is either a mechanical control interface device, a touch screen control interface device, a remote wireless control interface device, or a combination thereof Regardless, the control interface device 105 allows a user to adjust, manipulate, or select both the combined output light intensity from LED arrays 104, 104′ and 104″ (by changing and the combine output light color temperature from LED arrays 104, 104′ and 104″ (by changing the relative percentages of I₁, I₂, and I₃ that contribute to I_{T}).

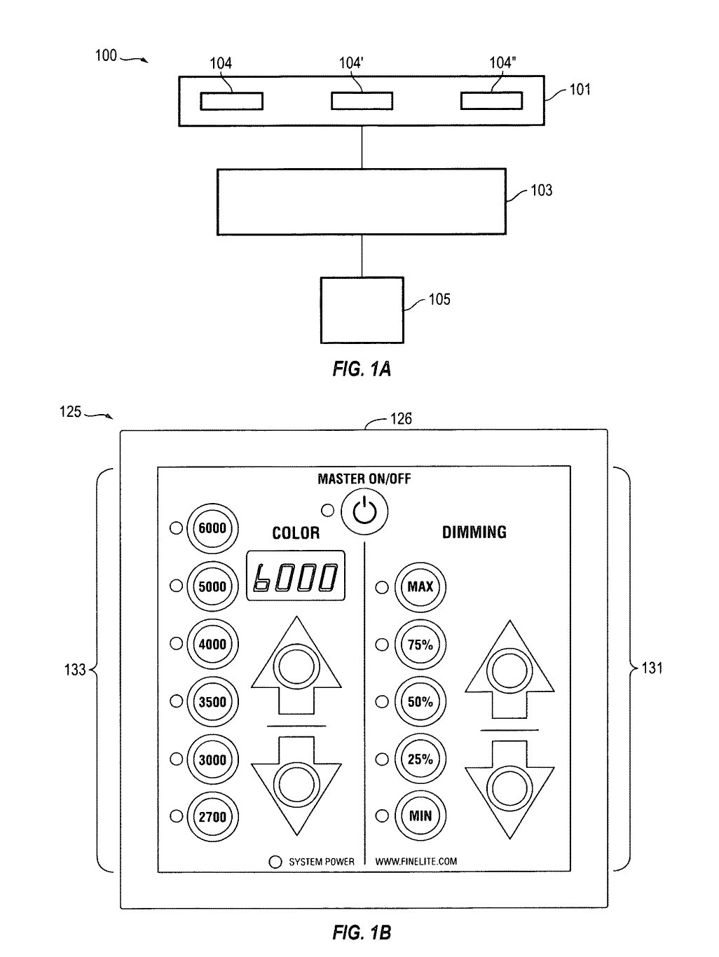

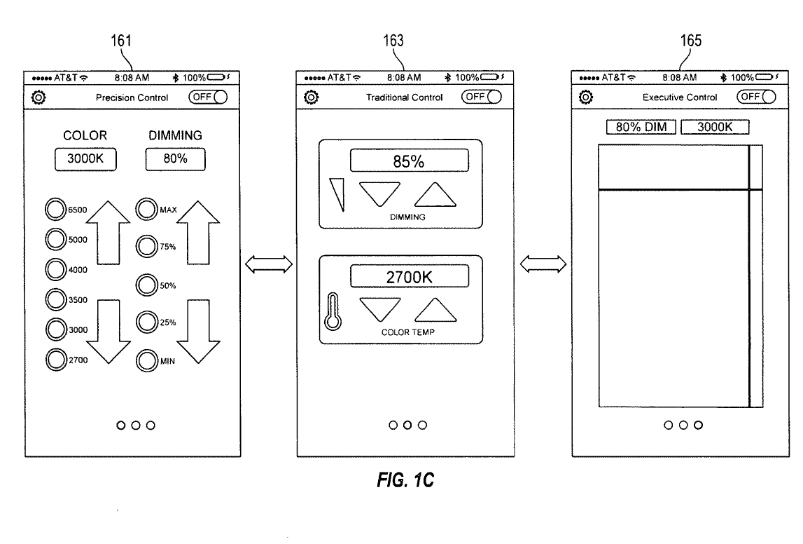

FIG. 1B shows a view 125 of a control interface device 126 for controlling output lighting from an advanced control lighting system, in accordance with the embodiments of the invention. The control interface device 126 is divided into two control zones 131 and 133. In the control zone 131, a user can select a total light output intensity I_{T} from a set of LED light fixtures within the lighting system, that include LED fixtures similar to the LED light fixture 101 described with reference to FIG. 1. The total light output intensity I_{T} is selected by touching a set buttons or by toggling up or down using arrows within the control zone 131. In the control zone 133, a user can select a total color temperature C_{T} from a set of LED light fixtures within the lighting system, that include LED fixtures similar to the LED light fixture 101 described with reference to FIG. 1. The total color temperature C_{T} is selected by touching a set buttons or by toggling up or down using arrows within the control zone 133. The control interface device 126 is portable, or mounted to a wall and preferably includes a master on and off switch for turning on and off a set or sets of LED light fixtures within the lighting system that are assigned to the control interface device 126.

In accordance with the embodiments of the invention a control interface device is a Bluetooth enabled control interface device that has a touch screen, such as a smart-phone or a computer. In operation, the Bluetooth enabled control interface device “pairs” with a Bluetooth transducer coupled to the control unit 103 (FIG. 1). The Bluetooth enabled control interface device runs software that generates one or more selectable graphical control interfaces 161, 163 and 165, such as shown in FIG. 1C. The graphical control interfaces 161, 163 and 165 allow a user to select or input target output light intensities and select or input target output light color temperatures. The graphical control interfaces 161 and 163 are both divided into two control zones, 161 being divided into two vertical control zones and 163 being divided in two horizontal control zones. As described above with reference to FIG. 1B, graphical control interfaces 161 and 163 include one control zone for selecting or adjusting a total light output I_{T} from a set of light fixtures within the lighting system and one control zone for selecting or adjusting a total color temperature C_{T} from the set of light fixtures within the lighting system. Preferably, one of the selectable graphical control interfaces 165 includes movable intersecting cross-hairs. In operation, a user drags or moves positions of the intersecting cross-hairs on the touch screen of the Bluetooth enabled control interface device to select a total light output I_{T} from the set of light fixtures within the lighting system and a total color temperature C_{T} from the set of light fixtures within the lighting system either individually or simultaneously.

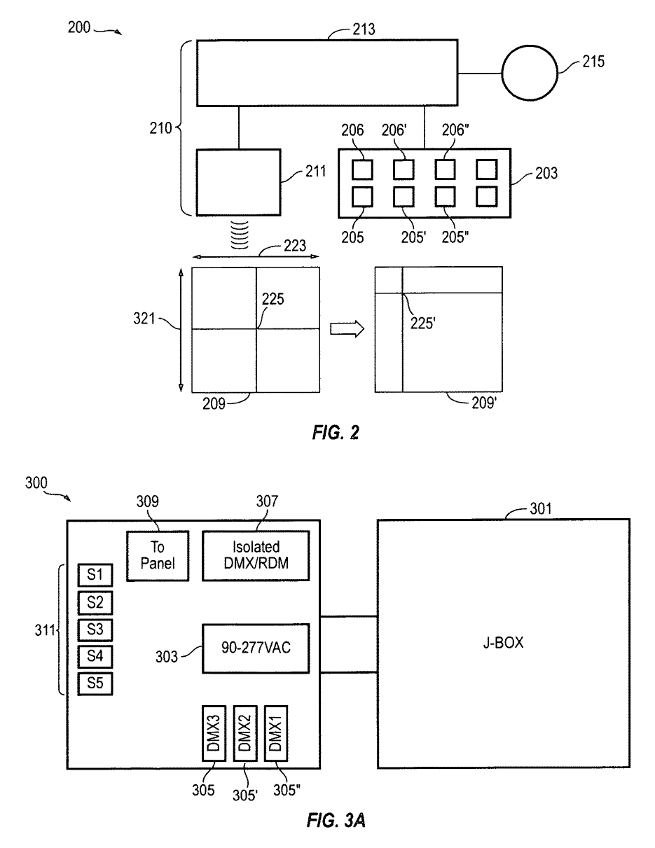

FIG. 2 shows a schematic representation 200 of an advanced control lighting system 210 with a wireless transducer 211 for receiving and processing input control signals from a remote control interface control device and/or transmitting system status signals to the a remote control interface device (not shown), such as a smart-phone or a computer. The system 210 includes a set of LED light fixtures. Each of the LED light fixtures within the set of LED light fixtures 201 includes at least two different sets of LEDs 205/206, 205′/206′ and 205″/206″ that emit different output spectra. The system further includes a control unit 213. The control unit 213 includes all the necessary electrically components, including one or more computing units (CPUs) for running software and analyzing control signals received from sensors 215 and control interface devices and connectors for coupling to and for powering the set of LED light fixtures 203. The sensors 215 can include any number of sensors including but not limited to light sensors for measuring ambient light and/or measuring and calibrating light outputs from the set of light fixtures 203 and motion or occupancy sensors. Preferably, at one of the sensors 215 is used to measure and calibrate light outputs from set of light fixtures 203 such that a selected or target output light intensity and selected or target output light color temperature is maintained. In operation the light sensor measures white light from ambient light. The light sensor send the appropriate control command signals to control unit 213 and the control unit 213 adjusts the total output intensity of from the set of LED light fixtures 203 as wells as the relative intensities of different LEDs 205/206, 205′/206′ and 205″/206″ within the set LED light fixtures 203 to compensate for white light provided by the ambient light.

Still referring to FIG. 2, in a preferred embodiment of the invention the lighting system 210 includes a Bluetooth transmitter 211 that allows a user to “pair” a Bluetooth enabled wireless remote control interface device, such as a smart-phone or computer, with the lighting system 210. Preferably, the Bluetooth enabled wireless remote control interface device includes a touch screen and is capable of running application software to display a graphical control interface (FIG. 1C) that includes movable and intersecting cross-hairs, such as described above. The axis 321 on the graphical control interface 165 can, for example, represent output light intensity and the axis 223 on the graphical control interface 165 can, for example, represent output light color temperature. By moving the cross-hairs to different locations 225 and 225′ within the frame of touch screen of the blue-tooth enabled wireless remote control interface device, the light outputs from the set of light fixtures 203 are adjusted to new output light intensities and new output light color temperatures. For example, the graphical representation 209′ corresponds to a lower light output intensity and cooler output light color that the corresponding to the graphical representation 209.

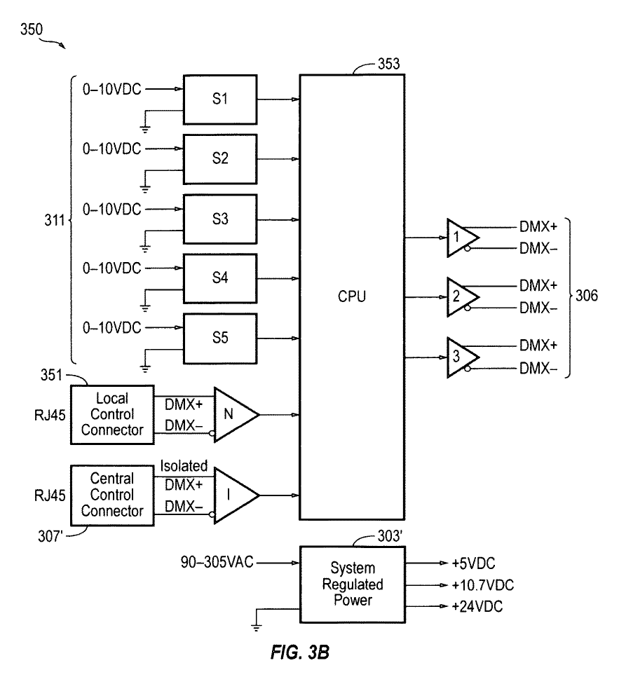

Referring now to FIG. 3A showing a power control center 300 and FIG. 3B showing a signal control center 350 for powering and controlling the advanced control lighting system of the present invention. The power control center 300 includes a junction box 301 that provides power to a power supply 303. The power control center 300 includes a panel 309 that powers a local control connector 351 of the signal control center 350 and an isolated DMX/RMX 307 that powers a central control connector 307′) of the signal control center 350 through a regulated power source 303′. The power control center 300 also provides power for a set of sensors 311 in communication with a control center CPU 353 of the signals control center 350. The power control center 300 also provided power to a set master DMX output connectors 306 through DMX connectors 305, 305′ and 305″ and the regulated power source 303′.

In operation, the signal control center CPU 353 receives control command signals from the local control connector 351, the central control connector 307′ and the set of sensors 311. Based on the control command signals the signal control center CPU will adjust the output signals to the set master DMX output connectors 306 that control LED light fixtures in the system of the present invention.

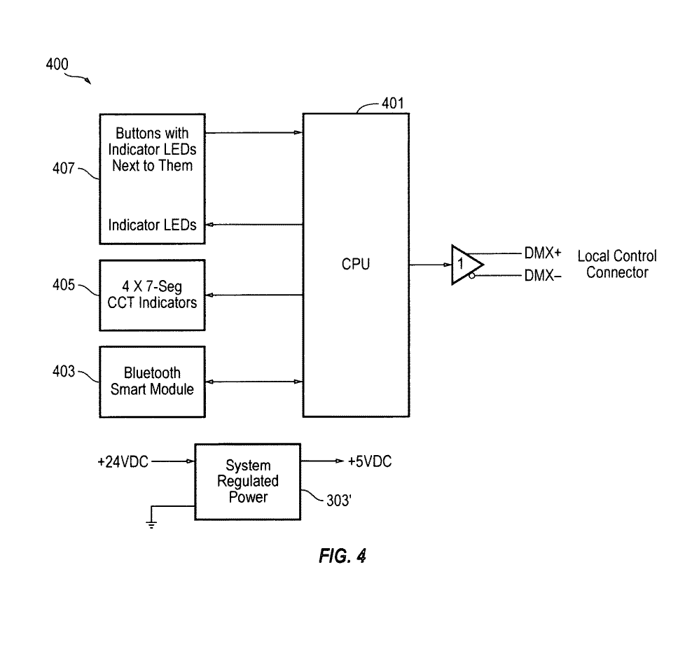

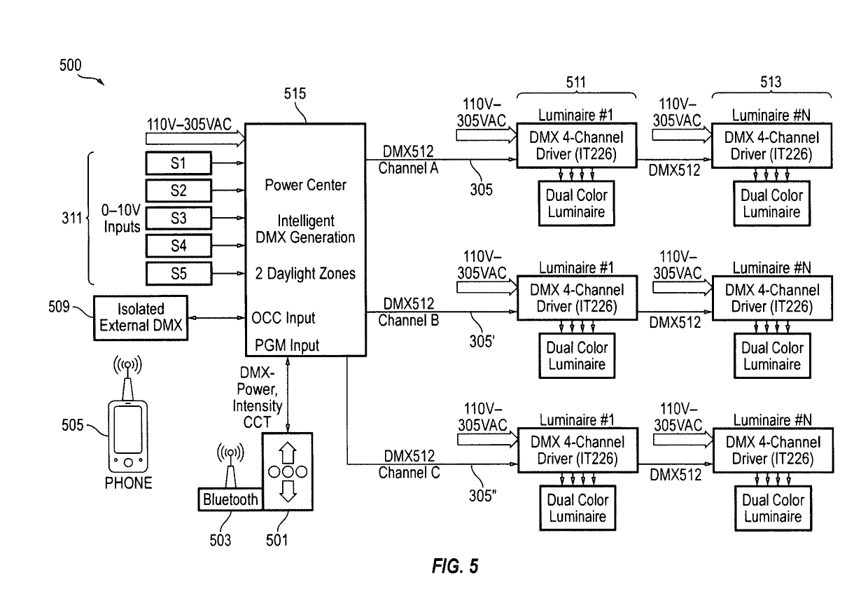

FIG. 4 shows a schematic representation of a user control interface 400 powered by a regulated power source 303′ and configured for controlling the advanced control lighting system, in accordance with the embodiments of the invention. The user control interface 400 can include an control interface 407 that is coupled to an control interface device 105 (FIG. 1B). The control interface includes button or switch contacts for selecting output light intensities and selecting output light color temperatures, such as described above. The control interface 400 can also include LED indicators to show values of output light intensities and output light color temperatures that have been selected through the buttons or switches of a control interface device 105 (FIG. 1B). The user control interface 400 also includes indicators 405, such as color corrected temperature indicators, that provide an indication of a status of the LED light fixtures within the system that are assigned to the user control interface 400. The user control interface 400 also preferably includes a bluetooth module 403 that allows advanced control lighting system to be control by bluetooth enabled wireless remote control device, such as described with reference to FIG. 2 above and FIG. 5 below. In operation, control command signals are input through the user control interface 400 from the control interface 407, via control interface device 105, or the bluetooth module 403, via bluetooth enabled wireless remote control device. The control command signals are processed by a control interface CPU 401 and an output control signals are transmitted to the local control connector 351 (FIG. 3B) and LED light fixtures assigned to the user control interface 400 are adjusted according to the control command signals through the signal control center CPU 353 and the set master DMX output connectors 306 (FIG. 3B)

FIG. 5 shows a schematic representation of an advanced control lighting system 500 in accordance with a preferred embodiment of the invention. The system in sets of LED light fixtures 513 and 513 connected to three master DMX output connectors 305, 305′ and 305″ (Channel A, Channel B and Channel C). Each of the LED light fixtures in the sets LED light fixtures 511 and 513 are dual color luminaires (meaning each have two sets of different white LEDs). The system includes a master control center 515 with sensors 311, a power control center 300 (FIG. 3A), the signal control center 350 (FIG. B) and user control interface 400 (FIG. 4) and an isolated eternal DMX 509. Other features and specifications of the advanced control lighting system 500, the master control center 515, the connections 305, 305′ and 305″ and the LED light fixtures 511 and 513 are provided in the co-pending U.S. provisional patent applications Ser. Nos. 62/122,621, 62/178,705 and 62/230,798 that are all incorporated herein by reference.

As described above, the master control center 515 preferably includes a Bluetooth module 503. The Bluetooth module 503 allows a Bluetooth enabled wireless remote control device 505, such a smart-phone, to provide control command signals to the system and control the sets of LED light fixtures 511 and 513 through one or more graphical control interfaces 501. Preferably, a user can selectively control output signals provided through connectors 305, 305′ and 305″ corresponding (Channel A, Channel B and Channel C) individually or independently.

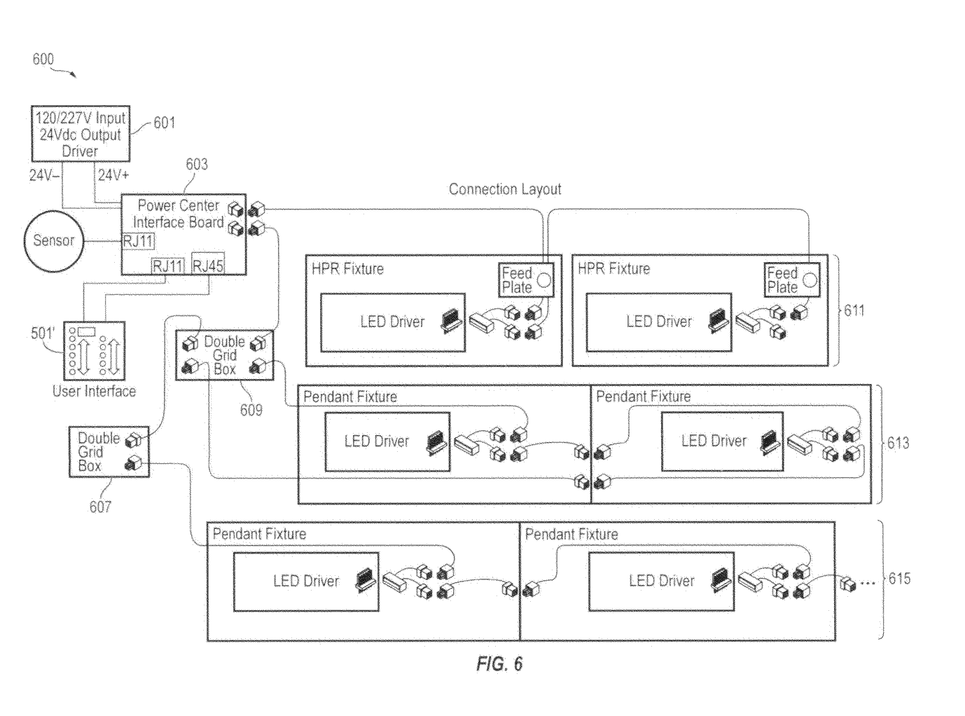

FIG. 6 shows a schematic representation of a connection layout for the advanced control lighting system 600 of the present invention. In the system 600, sensors and a user interface 501′ are electrically couple to a power center interface board 603 through RJ11 and RJ45 plugs. The

Power center interface board 603 is electrically coupled to and input/output driver circuit 601. The sets of LED light fixtures 611, 613 and 615 are coupled to the power interface board 603 through double grid boxes 607 and 609. Preferably, the advanced control lighting system 600 is connected and assembled through two-part plug connectors, as shown, such that installing the system and maintaining the system 600 requires a minimized effort.

The present invention has been described in terms of specific embodiments incorporating details to facilitate the understanding of the principles of construction and operation of the invention. As such, references herein to specific embodiments and details thereof are not intended to limit the scope of the claims appended hereto. It will be apparent to those skilled in the art that modifications can be made in the embodiments chosen for illustration without departing from the spirit and scope of the invention.

What is claimed is:

1. A lighting system comprising:
a) one or more LED light fixtures, each comprising at least two different sets of LED arrays that emit different output spectra and that include a component of white light, wherein the different output spectra combine to produce a combined output light intensity and a combined output light color temperature;
b) a control unit coupled to the one or more LED light fixtures for controlling power to the one or more LED light fixtures;
c) one or more control interface devices coupled to control unit for independently controlling the combined output light intensity and the combined output light color temperature.

2. The lighting system of claim 1, further comprising sensors coupled to the control unit for automatically adjusting one or more of the combined output light intensity and the combined output light color temperature based on a measured or detected condition.

3. The lighting system of claim 2, wherein the sensors include daylight sensors and the measured or detected condition is ambient light.

4. The lighting system of claim 2, wherein the sensors include a white light sensor and wherein the measured or detected condition is an amount of white light in ambient light.

5. The lighting system of claim 2, wherein the sensors include a occupancy sensor and wherein the measured or detected condition is the presence of an occupant in a vicinity of the one or more LED light fixtures.

6. The lighting system of claim 1, wherein the one or more control interface devices include a touch screen device that displays movable intersecting cross-hairs, wherein positions of the intersecting cross-hairs on the touch screen device corresponds to a selected combined output light intensity and a selected combined output light color temperature.

7. The lighting system of claim 1, further comprising a Bluetooth transmitter for pairing the one or more control interface devices wirelessly to the control unit.

8. The lighting system of claim 7, wherein the one or more control interface devices includes a smart-phone or a computer.

9. The lighting system of claim 8, wherein the one or more control interface devices runs a control program that generates one or more graphical control interfaces on a touch screen.

10. A lighting system comprising:
a) one or more LED light fixtures, each comprising at least two different sets of LED arrays that emit different output spectra that include a component of white light, wherein the different output spectra combine to produce a combined output light intensity and a combined output light color temperature;
b) a control unit coupled to the one or more LED light fixture for controlling power to the one or more LED light fixtures;
c) a control interface device with a wireless transducer for wirelessly coupling to control unit for independently controlling the combined output light intensity and the combined output light color temperature remotely.

11. The lighting system of claim 10, further comprising sensors coupled to the control unit for automatically adjusting one or more of the combined output light intensity and the combined output light color temperature based on a measured or detected condition.

12. The lighting system of claim 11, wherein the sensors include daylight sensors and the measured or detected condition is ambient light.

13. The lighting system of claim 11, wherein the sensors include a white light sensor and wherein the measured or detected condition is an amount of white light in ambient light.

14. The lighting system of claim 11, wherein the sensors include a occupancy sensor and wherein the measured or detected condition is occupancy of a persons in a vicinity of the occupancy sensor.

15. The lighting system of claim 10, wherein the control interface device runs a control interface program that generates multiple and selectable graphical control interfaces for independently controlling the combined output light intensity and the combined output light color temperature remotely from a touch screen of the control interface device.

16. The lighting system of claim 15, wherein one of the multiple and selectable graphical control interfaces includes a graphical control interface that displays movable intersecting cross-hairs, wherein the positions of the intersecting cross-hairs on the touch screen of the control interface device corresponds to a selected combined output light intensity and a selected combined output light color temperature.

17. The lighting system of claim 10, the wireless transducer includes a Bluetooth transmitter for pairing the control interface device with the control unit.

18. A method for generating lighting comprising:
a) emitting light from at least two different sets of LEDs that emit different output spectra that include a component of white light, wherein the different output spectra combine to produce a combined output light intensity and a combined output light color temperature;
b) selecting a target combined output light intensity and a target combined output light color temperature; and
c) adjusting the relative intensities of the different outputs spectra from at least two different sets of LEDs to reach the target combined output light intensity and the target combined output light color temperature.

19. The method of claim 18, wherein the target combined output light intensity and the target combined output light color temperature is selected from one more control interface devices that is wirelessly coupled to control unit for independently controlling the combined output light intensity and the combined output light color temperature.

20. The method of claim 18, further comprising measuring or detecting an amount white light in ambient light and using the amount of white light measured or detected to adjust relative intensities of the at least two different sets of LEDs to maintain the target combined output light intensity and the target combined output light color temperature.
